(19) United States
(12) Patent Application Publication
(10) Pub. No.: US 2017/0327099 A1
(43) Pub. Date: Nov. 16, 2017

(54) WORKING MEDIUM CIRCUIT FOR A HYDRODYNAMIC MACHINE

(71) Applicant: Voith Patent GmbH, Heidenheim (DE)

(72) Inventor: Ravi Schade, Crailsheim (DE)

(73) Assignee: Voith Patent GmbH, Heidenheim (DE)

(21) Appl. No.: 15/668,960

(22) Filed: Aug. 4, 2017

Related U.S. Application Data
(63) Continuation of application No. PCT/EP2016/050870, filed on Jan. 18, 2016.

(30) Foreign Application Priority Data
Feb. 4, 2015 (DE) 10 2015 201 910.1

(51) Int. Cl. B60T 10/02; F15B 21/04; F15B 15/14; F16D 57/04

(52) U.S. Cl. CPC B60T 10/02; F16D 57/04; F15B 21/044; F15B 15/1485; F15B 21/041; F15B 2211/715

(57) ABSTRACT

A working medium circuit for a hydrodynamic machine. The working medium circuit includes a working medium container, an inflow line, an emptying line, and a heat exchanger. The working medium can be moved out of the working medium container into the working chamber for a first operating state, in particular the braking mode, and the working medium can be moved out of the working chamber back into the working medium container for a second operating state, in particular the non-braking mode. For aerating and ventilating, the working chamber is connected at least indirectly via a ventilating line to a chamber which has a ventilating device with respect to the surroundings and in which working medium can collect.

### CROSS REFERENCE TO RELATED APPLICATIONS

This is a continuation of PCT application No. PCT/EP2016/050870, entitled “WORKING MEDIUM CIRCUIT FOR A HYDRODYNAMIC MACHINE”, filed Jan. 18, 2016, which is incorporated herein by reference.

### BACKGROUND OF THE INVENTION

### 1. Field of the Invention

The present invention relates to a working medium circuit for a hydrodynamic machine that is arranged in a drive train with a drive motor, as installed in motor vehicles, for examples buses and trucks. In each case, such hydrodynamic machines include a working medium circuit through which the working medium can circulate.

### 2. Description of the Related Art

Such retarders are known to the expert in various designs. The retarder essentially comprises a stator and a rotor which together form a toroidal working chamber. The working medium circuit essentially comprises a working medium container, an inflow line, an emptying line and a cooler. Means are also provided by way of which in a first operating state, in particular the braking mode, the working medium can be moved out of the working medium container into the working chamber, and in a second operating state, in particular the non-braking mode the working medium can be moved out of the working chamber back into the working medium container.

In the braking mode, a circular flow is created in the working medium circuit by way of which the working medium that is heated in the working chamber by the hydrodynamic flow is pumped to the cooler and from there back into the working chamber.

Ventilation of the hydrodynamic circuit occurs via an aerating and ventilating unit that is installed in the working medium circuit and vents into the atmosphere. Aerating and ventilating is especially important in order to be able to quickly switch from one operating state to the other and in order to prevent intermixing of air with the working medium, wherein during switching the working chamber must either be vented or aerated. Various means are known for preventing the working medium from getting into the surroundings. Moreover, contamination of the working medium which would cause a reduction in the operational readiness must be prevented.

Known working media for retarders are oils or aqueous solutions, in particular cooling water from the vehicle's cooling circuit. Due to increased demands, it is necessary to prevent leakage of working medium into the environment and to extend the change intervals for the working medium.

What is needed in the art is a working medium circuit that provides improved operational readiness.

### SUMMARY OF THE INVENTION

The present invention a working medium circuit for a hydrodynamic machine provides. Additional embodiments and possible solution variations are described in the dependent sub-claims.

The working medium circuit for a hydrodynamic machine which is arranged in a drive train with a drive motor includes at least one each rotor blade wheel and stator blade wheel which are arranged in a common housing and together form a toroidal working chamber. The working chamber can be filled with and emptied of working medium in order to switch the hydrodynamic machine on and off. The working medium circuit includes a working medium container, an inflow line, an emptying line, a heat exchanger and devices by way of which the working medium can be moved out of the working medium container into the working chamber in a first operating state, in particular the braking mode. The working medium can be moved out of the working chamber back into the working medium container in a second operating state, in particular the non-braking mode. The circulation of the working fluid is brought about by the rotor blade wheel.

It is moreover provided that for aerating and ventilating, the working chamber is connected at least indirectly via a ventilating line with an unpressurized chamber which has a ventilating device vis-à-vis the surroundings and in which working medium can collect.

The working medium of the hydrodynamic machine can moreover be oil and the chamber can be the oil container of the drive motor or the transmission. This simplifies aerating and ventilating of the working chamber. Provision may thus be made to link the aeration and ventilation of the working chamber with the air space of the transmission or drive motor, thereby utilizing the aerating and ventilating device of the transmission or drive motor also for the working chamber.

The connection can occur internally via the retarder housing, transmission housing or more specifically the internal combustion engine housing or via an external line. This solution is conceivable for retarders having a common oil supply with the transmission or the internal combustion engine, as well as for retarders having a separate oil pan or oil supply. The oils that are used for transmission and retarder or combustion engine and retarder are herein selected such that they are miscible with one another.

In the embodiment with the separate retarder oil pan, the chamber can moreover be connected indirectly via a compensating line with the working medium container. The oil volumes of the two oil supplies can thus be balanced with one another via an internal channel or an external line.

The chamber may be located at a geodetically higher level than the working medium container and may be connected with the working medium container in such a way that the working medium flows out of this atmospherically connected container into the working medium container due to gravity, so that no separate pump is required.

Furthermore, a valve may be arranged in the compensating line in order to be able to influence the flow into the working medium container and in order to be able to interrupt this connection.

It may also be provided that the device for switching between operational modes include a pump. By way of the pump the working chamber can be filled with working medium on the one hand, and on the other hand the leakage losses that occur in the braking mode can be compensated for.

In another embodiment, the pump includes at least three control ranges—a first control range during filling of the hydrodynamic machine, a second control range during braking mode, and a third control range during non-braking mode.

In one embodiment, a filter may be located upstream from the pump, so that the oil quality required for retarder operation is always ensured.

Moreover, in the case of hydrodynamic oil retarders that share a common oil supply with the transmission, the pump may be a displacement pump, located on the retarder or transmission side, by way of which both units are supplied with oil.

Furthermore, a switchable quick-draining line may be provided for rapid emptying of the working chamber.

In addition, an alternative is also conceivable whereby the chamber includes the oil container of the drive motor and the working medium container and whereby a common container is created.

In the non-braking operating mode of the retarder, the pump can be connected/switched with the oil circuit in such a way that—for cooling—an oil stream is pumped continuously from the chamber of the drive motor or the transmission and/or the working medium container through the heat exchanger of the retarder.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates an embodiment of an oil circuit for a hydrodynamic machine with ventilation;

FIG. 2 illustrates an oil circuit with an adjustable pump; and

FIG. 3 illustrates an oil circuit with a non-adjustable pump.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

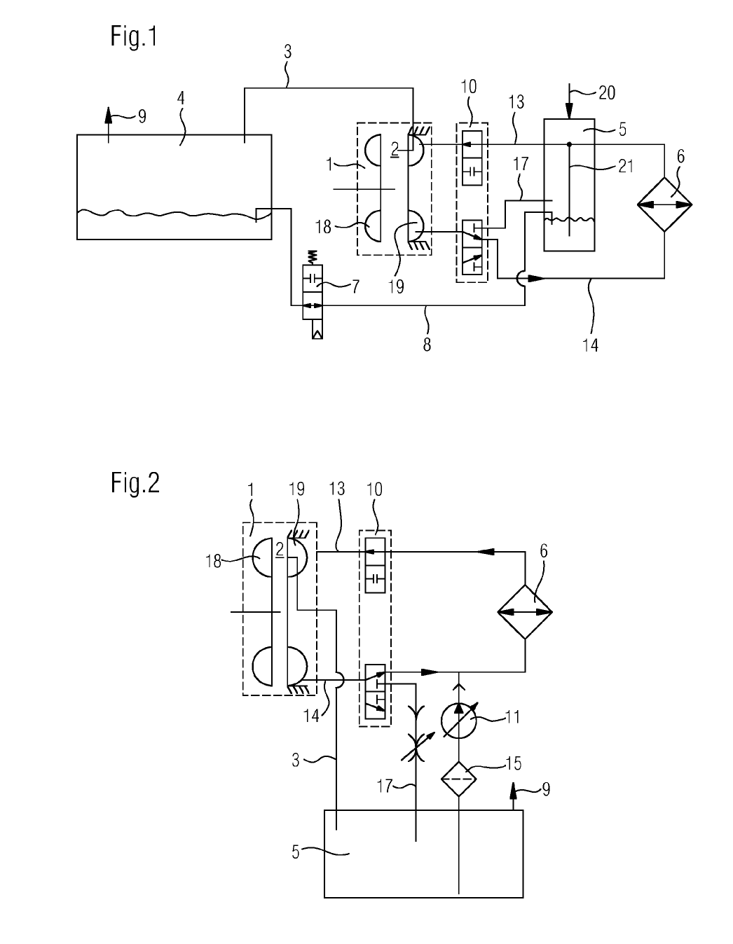

FIG. 1 shows a first embodiment of the invention, wherein an oil circuit for a hydrodynamic machine with ventilation is illustrated. The hydrodynamic machine, or more specifically the retarder, includes one each rotor and stator blade wheel 18, 19 that are arranged in a common housing and together form a toroidal working chamber 2. For the purpose of switching on and off, the retarder can be filled with and emptied of working medium.

The working medium circuit consists of a working medium container 5, an inflow line 13, an emptying line 14, a heat exchanger 6, as well as devices 20, 11 by way of which in a first operating state, in particular the braking mode, the working medium can be moved out of working medium container 5 into working chamber 2, and in a second operating state, in particular the non-braking mode the working medium can be moved out of working chamber 2 back into working medium container 5. The circulation of the working medium is caused by rotor blade wheel 18. In this embodiment, it is provided that the retarder adjustment occurs by way of compressed air 20 that acts upon the working medium in working medium container 5 and through which the working medium is pressed into working chamber 2 via a standpipe 21.

Via the shifting position of the valves of valve unit 10, the lines are switched for the filling mode, the braking mode or the emptying mode. Thus, the circulation in the braking mode occurs via inflow line 13 and emptying line 14 via heat exchanger 6 and working chamber 2.

Alternatively, the embodiment illustrated in FIG. 1 can also be designed without valve unit 10. Switching then occurs only via the pressurization device.

Ventilation of working chamber 2 occurs via ventilating line 3 through which the connection from the center of working chamber cross section 2 into chamber 4 is established. An oil discharge device can be provided in chamber 4, and ventilation occurs via venting valve 9.

An oil discharge device can be located before or integrated in aerating and ventilating unit 9.

To compensate for oil losses that occur via the ventilating line into chamber 4, a compensating line 8 with a switching valve 7 is provided. The chamber, or at least the oil level in the chamber, may be arranged geodetically higher than the working medium container, or more specifically the oil level thereof, so that the level compensation can occur without additional devices.

FIG. 2 illustrates a section of an oil circuit with an adjustable pump 11. In the case of hydrodynamic oil retarders with their own oil supply, a displacement pump 11 is utilized for filling of working chamber 2 and for provision of a desired oil pressure in working chamber 2 for adjustment and control of the retarder braking torque.

For this purpose, the outlet of displacement pump 11 is connected with emptying line 14 of the working medium circuit. This connection causes a pressure equilibrium during operation between the outlet of displacement pump 11 and the outlet of the hydrodynamic circuit. This influences the fill level of the hydrodynamic circuit and thereby the provided retarder braking torque.

An adjustable as well as a non-adjustable pump can be used as the displacement pump. An adjustable pump offers the advantage that during non-braking operation the mechanical power consumption of pump 11 can be reduced.

With hydrodynamic oil retarders that share a common oil supply with the transmission, retarder-specific or transmission-specific displacement pumps can be dispensed with in the case of transmissions with their own pump 11. This one pump then assumes the oil supply for lubrication and cooling of the transmission, as well as the supply of the working medium in working chamber 2 that is required for the braking operation.

A heat exchanger 6 is built into the working medium circuit for cooling, wherein heat exchanger 6 can also be used for cooling the common oil supply.

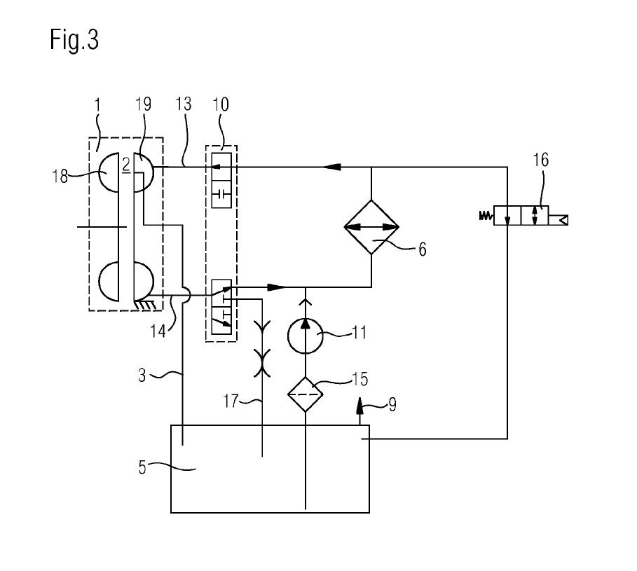

FIG. 3 illustrates an additional oil circuit with an unregulated pump, wherein an additional switchable connecting line is provided from inflow line 13 into working medium container 5 for faster emptying of the working chamber. This supports emptying or adjustment of the fill level of retarder working chamber 2.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### COMPONENT IDENTIFICATION LISTING

1 Retarder
2 Working chamber
3 Aerating and ventilating line
4 Oil container, drive motor or transmission
5 Working medium container
6 Heat exchanger
7 Oil compensating valve
8 Compensating line
9 Aerating and ventilating device
10 Valves
11 Pump
13 Inflow line
14 Emptying line
15 Filter
16 Switching valve for cooling during non-braking operation
17 Return flow line
18 Rotor
19 Stator
20 Pressurization device
21 Stand pipe

What is claimed is:

1. A working medium circuit for a hydrodynamic machine which is arranged in a drive train with a drive motor, said hydrodynamic machine includes at least one rotor blade wheel and at least one stator blade wheel which are arranged in a common housing and together form a toroidal working chamber, said working chamber can be filled with and emptied of a working medium in order to switch the hydrodynamic machine on and off, said working medium circuit comprising:
a working medium container;
an inflow line fluidly connected to the working chamber;
an emptying line fluidly connected to the working chamber;
a heat exchanger, wherein the working medium circuit is configured for moving the working medium out of the working medium container into the working chamber in a first operating state and moving the working medium out of the working chamber back into the working medium container in a second operating state, and wherein the circulation of the working medium is brought about by said at least one rotor blade wheel; and
an unpressurized chamber fluidly connected at least indirectly via a ventilating line with said working chamber and configured for aerating and venting, said unpressurized chamber has a ventilating device with respect to the surroundings and in which working medium can collect.

2. The working medium circuit according to claim 1, wherein the working medium of the hydrodynamic machine is oil and said unpressurized chamber is an oil container of the drive motor or an oil container of a transmission.

3. The working medium circuit according to claim 1, wherein said unpressurized chamber is fluidly connected at least indirectly via a compensating line with said working medium container.

4. The working medium circuit according to claim 1, wherein said unpressurized chamber is located at a geodetically higher level than said working medium container and is connected with said working medium container in such a way that the working medium flows out of said unpressurized chamber to a defined oil level into said working medium container due to gravity.

5. The working medium circuit according to claim 3, wherein a valve is arranged in said compensating line.

6. The working medium circuit according to claim 1, further including a pump that is configured for moving the working medium.

7. The working medium circuit according to claim 6, wherein said pump includes at least three control ranges wherein a pump output is adaptable in a first operating state during filling of the hydrodynamic machine, in a second operating state during a braking mode, and a third operating state during a non-braking mode.

8. The working medium circuit according to claim 6, wherein a filter is located upstream from said pump.

9. The working medium circuit according to claim 6, wherein a switchable quick-draining line is provided for rapid emptying of the working chamber.

10. The working medium circuit according to claim 6, wherein said unpressurized chamber, an oil container of the drive motor, and said working medium container are formed by a common container.
